(19) United States
(12) Patent Application Publication
(10) Pub. No.: US 2026/0038086 A1
(43) Pub. Date: Feb. 5, 2026

(54) IMAGE PROCESSING APPARATUS, CONTROL METHOD OF IMAGE PROCESSING APPARATUS, VEHICLE, AND STORAGE MEDIUM

(71) Applicant: HONDA MOTOR CO., LTD., Tokyo (JP)

(72) Inventors: Gakuyo Fujimoto, Wako-shi (JP); Shigenobu Saigusa, Wako-shi (JP); Taku Hanakawa, Tokyo (JP)

(73) Assignee: HONDA MOTOR CO., LTD., Tokyo (JP)

(21) Appl. No.: 19/354,940

(22) Filed: Oct. 10, 2025

Related U.S. Application Data
(63) Continuation of application No. PCT/JP2023/022422, filed on Jun. 16, 2023.

(51) Int. Cl. G06T 3/60; G06T 5/80; G06T 11/00

(52) U.S. Cl. CPC G06T 3/60; G06T 5/80; G06T 11/00; G06T 2210/22

(57) ABSTRACT

An image processing apparatus configured to process a captured image acquired by an imaging unit provided on a side mirror of a vehicle, the image processing apparatus comprising: an image conversion unit configured to convert the captured image based on a state of the side mirror, wherein in a case where the captured image is acquired in a first state where the state of the side mirror is folded, the image conversion unit is configured to convert the captured image so as to have the same orientation as in a case where the captured image is acquired in a second state where the side mirror is not folded.

### CROSS-REFERENCE TO RELATED APPLICATION(S)

This application is a continuation of International Patent Application No. PCT/JP2023/022422 filed on Jun. 16, 2023, the entire disclosures of which are incorporated herein by reference.

### BACKGROUND OF THE INVENTION

### Field of the Invention

The present invention relates to an image processing apparatus, a control method of the image processing apparatus, a vehicle, and a storage medium.

### Description of the Related Art

Japanese Patent Laid-Open No. 2010-287163 discloses a technique where image data acquired by an imaging camera, which is installed on a side mirror of a self-vehicle and images the rear side of the self-vehicle, is combined with image data acquired by another imaging camera and displayed.

However, Japanese Patent Laid-Open No. 2010-287163 does not consider a state where the side mirror is folded. For example, when traveling forward on a narrow road or parking in a narrow parking space, there is a need to travel at low speed with a side mirror folded, while checking surrounding images. The technique described in Japanese Patent Laid-Open No. 2010-287163 has a problem that the orientation of an image changes with the side mirror folded, which makes it difficult for a user to appropriately grasp the surrounding environment.

### SUMMARY OF THE INVENTION

The present invention has been made in view of the above problem, and provides a technique for a user to appropriately grasp a surrounding environment.

According to one aspect of the present invention, there is provided an image processing apparatus configured to process a captured image acquired by an imaging unit provided on a side mirror of a vehicle, the image processing apparatus comprising:
an image conversion unit configured to convert the captured image based on a state of the side mirror, wherein
in a case where the captured image is acquired in a first state where the state of the side mirror is folded, the image conversion unit is configured to convert the captured image so as to have the same orientation as in a case where the captured image is acquired in a second state where the side mirror is not folded.

Further features of the present invention will become apparent from the following description of exemplary embodiments with reference to the attached drawings.

### BRIEF DESCRIPTION OF THE DRAWINGS

FIG. 1 is a block diagram of a vehicle according to an embodiment.

FIG. 2A is a diagram illustrating an imaging range in a horizontal direction of each fisheye camera according to an embodiment.

FIG. 2B is a diagram illustrating an imaging range in a vertical direction of a left-side fisheye camera according to an embodiment.

FIG. 2C is a diagram illustrating an imaging range in a vertical direction of a rear-side fisheye camera according to an embodiment.

FIG. 3 is a flowchart illustrating a procedure of processing performed by an image processing apparatus according to an embodiment.

FIG. 4 is an explanatory diagram of processing on a captured image in a state where a side mirror according to an embodiment is folded.

FIG. 5 is an explanatory diagram of processing on a captured image in a state where a side mirror according to an embodiment is not folded.

FIG. 6 is a diagram illustrating an example of superimposition of a virtual line according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Configuration>

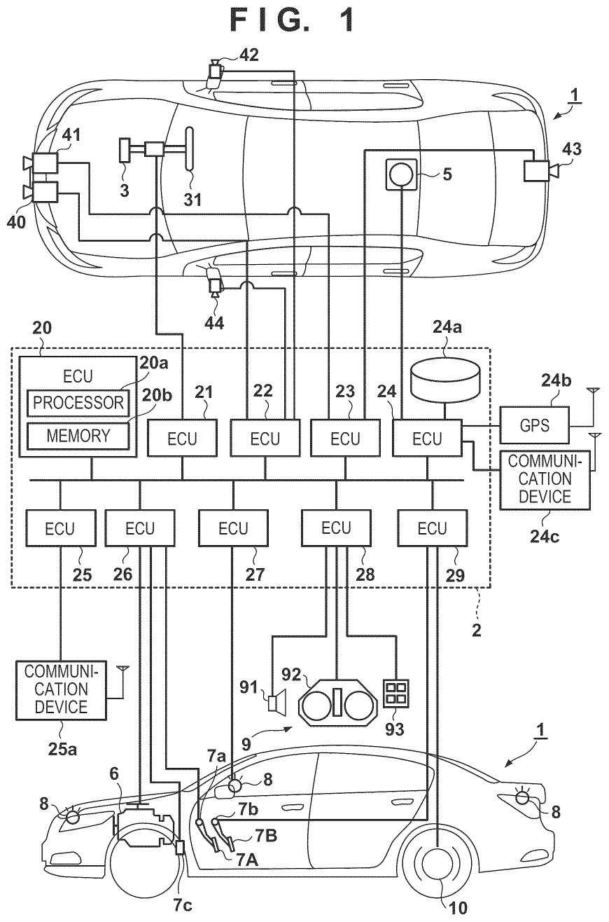

FIG. 1 is a block diagram of a vehicle 1 according to an embodiment. In FIG. 1, an outline of the vehicle 1 is illustrated in a plan view and in a side view. The vehicle 1 is, for example, a four-wheeled passenger vehicle of a sedan type. The vehicle 1 may be such a four-wheeled vehicle, a two-wheeled vehicle, or another type of vehicle.

The vehicle 1 includes a vehicle control device 2 (hereinafter simply referred to as a control device 2) that controls the vehicle 1. The control device 2 includes a plurality of electronic control units (ECUs) 20 to 29 connected through an in-vehicle network in a communication-enabling manner. Each ECU includes a processor such as a central processing unit (CPU), a memory such as a semiconductor memory, an interface with an external device, and the like. The memory stores programs to be executed by the processor, data to be used for processing by the processor, and the like. Each ECU may include a plurality of processors, memories, interfaces, and the like. For example, the ECU 20 includes one or more processors 20a and one or more memories 20b. Processing by the ECU 20 is executed by the processor 20a executing commands including the programs stored in the memory 20b. Instead of this, the ECU 20 may include an integrated circuit such as an application specific integrated circuit (ASIC) dedicated to execute processing by the ECU 20. A similar configuration applies to the other ECUs.

Hereinafter, functions and the like to be performed by each of the ECUs 20 to 29 will be described. Note that the number of ECUs and the functions to be performed can be designed as appropriate, and can be subdivided or integrated as compared with the present embodiment.

The ECU 20 executes control related to automated traveling of the vehicle 1. In automated driving, at least one of steering and acceleration/deceleration of the vehicle 1 is automatically controlled. The automated traveling by the ECU 20 may include automated traveling that does not require a traveling operation by a driver (which may also be referred to as automated driving) and automated traveling for assisting the traveling operation by the driver (which may also be referred to as driving assistance).

The ECU 21 controls an electric power steering device 3. The electric power steering device 3 includes a mechanism that steers the front wheels in accordance with a driver's driving operation (steering operation) on a steering wheel 31. In addition, the electric power steering device 3 includes a motor that exerts driving force for assisting the steering operation or automatically steering the front wheels, a sensor that detects a steering angle, and the like. In a case where the driving state of the vehicle 1 is automated driving, the ECU 21 automatically controls the electric power steering device 3 in response to an instruction from the ECU 20, and controls the advancing direction of the vehicle 1.

The ECUs 22 and 23 control detection units that detect surrounding situations of the vehicle, and perform information processing on detection results. The vehicle 1 includes one standard camera 40 and four fisheye cameras 41 to 44 as the detection units that detect the surrounding situations of the vehicle. The standard camera 40 and the fisheye cameras 42 and 44 are connected to the ECU 22. The fisheye cameras 41 and 43 are connected to the ECU 23. The ECUs 22 and 23 can extract an outline of a target or a lane division line (white line or the like) on a road by analyzing images captured by the standard camera 40 and the fisheye cameras 41 to 44. That is, the ECUs 22 and 23 can function as an image processing apparatus.

The fisheye cameras 41 to 44 are cameras each provided with a fisheye lens. Hereinafter, the configuration of the fisheye camera 41 will be described. The other fisheye cameras 42 to 44 may have a similar configuration. The angle of view of the fisheye camera 41 is wider than the angle of view of the standard camera 40. Therefore, the fisheye camera 41 can capture a wider area than the standard camera 40. An image captured by the fisheye camera 41 has a larger distortion than an image captured by the standard camera 40. Therefore, before analyzing the image captured by the fisheye camera 41, the ECU 23 may perform conversion processing (hereinafter, referred to as “distortion correction processing”) for reducing distortion on the image. On the other hand, before analyzing the image captured by the standard camera 40, the ECU 22 does not need to perform the distortion correction processing on the image. As described above, the standard camera 40 is an imaging device that captures an image that will not be a target of the distortion correction processing, and the fisheye camera 41 is an imaging device that captures an image that will be a target of the distortion correction processing. Instead of the standard camera 40, another imaging device that captures an image that will not be a target of the distortion correction processing, such as a camera provided with a wide-angle lens or a telephoto lens, may be used.

The standard camera 40 is attached at the center in a front portion of the vehicle 1, and captures an image of a surrounding situation on the front side of the vehicle 1. The fisheye camera 41 is attached at the center in the front portion of the vehicle 1, and captures an image of a surrounding situation on the front side of the vehicle 1. In FIG. 1, the standard camera 40 and the fisheye camera 41 are illustrated to be aligned in a horizontal direction. However, the arrangement of the standard camera 40 and the fisheye camera 41 is not limited to this, and they may be aligned in a vertical direction, for example. In addition, at least one of the standard camera 40 and the fisheye camera 41 may be attached to a front portion of the roof (for example, on the vehicle interior side of the windshield) of the vehicle 1. The fisheye camera 42 is attached to a right side mirror of the vehicle 1, and captures an image of a surrounding situation on the lower right side of the vehicle 1. The fisheye camera 43 is attached at the center in a rear portion of the vehicle 1, and captures an image of a surrounding situation on the rear side of the vehicle 1. The fisheye camera 44 is attached to a left side mirror of the vehicle 1, and captures an image of a surrounding situation on the lower left side of the vehicle 1.

The types, number, and attachment positions of the cameras of the vehicle 1 are not limited to the above-described examples. In addition, the vehicle 1 may include a light detection and ranging (LiDAR) or a millimeter wave radar as a detection unit that detects a target around the vehicle 1 and measures a distance to the target.

The ECU 22 controls the standard camera 40 and the fisheye cameras 42 and 44, and performs information processing on detection results. The ECU 23 controls the fisheye cameras 41 and 43, and performs information processing on detection results. The detection units that detect surrounding situations of the vehicle are divided into two systems, which can improve the reliability of the detection results. The image processing apparatus according to the present embodiment mainly corresponds to the ECU 22, but the ECU 22 and the ECU 23 may be integrated as one ECU and configured as the image processing apparatus.

The ECU 24 controls a gyro sensor 5, a GPS sensor 24b, and a communication device 24c, and performs information processing on detection results or communication results. The gyro sensor 5 detects a rotational movement of the vehicle 1. A course of the vehicle 1 can be determined based on the detection result of the gyro sensor 5, the wheel speed, and the like. The GPS sensor 24b detects a current position of the vehicle 1. The communication device 24c performs wireless communication with a server that provides map information and traffic information, and acquires these pieces of information. The ECU 24 can access a map information database 24a constructed in the memory, and the ECU 24 performs route search and the like from the current location to a destination. The ECU 24, the map database 24a, and the GPS sensor 24b constitute a so-called navigation device.

The ECU 25 includes a communication device 25a for vehicle-to-vehicle communication. The communication device 25a performs wireless communication with other surrounding vehicles to exchange information between the vehicles.

The ECU 26 controls a power plant 6. The power plant 6 is a mechanism that outputs a driving force for rotating the driving wheels of the vehicle 1, and includes, for example, an engine and a transmission. For example, the ECU 26 controls the output of the engine in response to a driver's driving operation (an accelerator operation or an acceleration operation) detected by an operation detection sensor 7a, which is provided on an accelerator pedal 7A, or switches a gear ratio of the transmission based on information such as a vehicle speed detected by a vehicle speed sensor 7c. In a case where the driving state of the vehicle 1 is automated driving, the ECU 26 automatically controls the power plant 6 in response to an instruction from the ECU 20, and controls the acceleration or deceleration of the vehicle 1.

The ECU 27 controls lighting devices (headlights, taillights, and the like) including direction indicators 8 (blinkers). In the example of FIG. 1, the direction indicators 8 are provided at the front portion, the door mirrors, and the rear portion of the vehicle 1.

The ECU 28 controls an input/output device 9. The input/output device 9 outputs information to the driver, and receives information input from the driver. A voice output device 91 notifies the driver of information by voice. A display device 92 notifies the driver of information by displaying an image. The display device 92 is disposed, for example, in front of a driver's seat, and constitutes an instrument panel or the like. Note that although voice and display have been given as examples here, information may also be notified by vibration or light. In addition, information may be notified by a combination of two or more of voice, display, vibration, and light. Furthermore, the combination or the mode of notification may be changed depending on the level (for example, a degree of urgency) of information to be notified. An input device 93 is a group of switches disposed at positions for the driver to be able to operate to give an instruction to the vehicle 1, but may also include a voice input device.

The ECU 29 controls a brake device 10 and a parking brake (not illustrated). The brake device 10 is, for example, a disc brake device, and is provided on each wheel of the vehicle 1 to apply resistance against rotation of the wheels, thereby decelerating or stopping the vehicle 1. The ECU 29 controls the activation of the brake device 10 in response to a driver's driving operation (a braking operation) detected by an operation detection sensor 7b provided on a brake pedal 7B, for example. In a case where the driving state of the vehicle 1 is automated driving, the ECU 29 automatically controls the brake device 10 in response to an instruction from the ECU 20 and controls the deceleration and stop of the vehicle 1. The brake device 10 and the parking brake can also be activated to maintain the stopped state of the vehicle 1. In addition, in a case where the transmission of the power plant 6 includes a parking lock mechanism, it is also possible to activate the parking lock mechanism to maintain the stopped state of the vehicle 1.

### <Imaging Range>

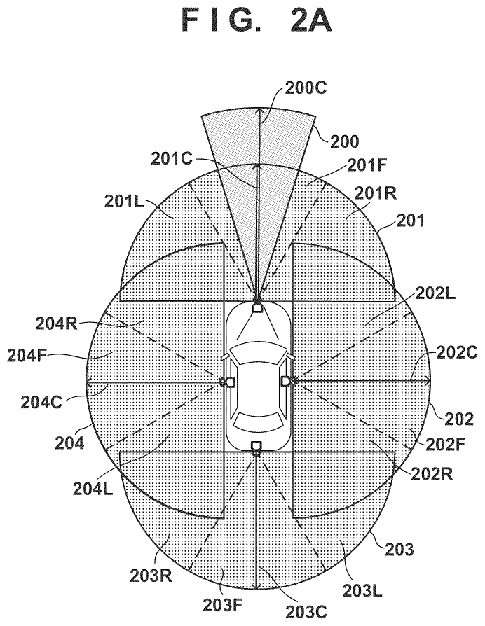

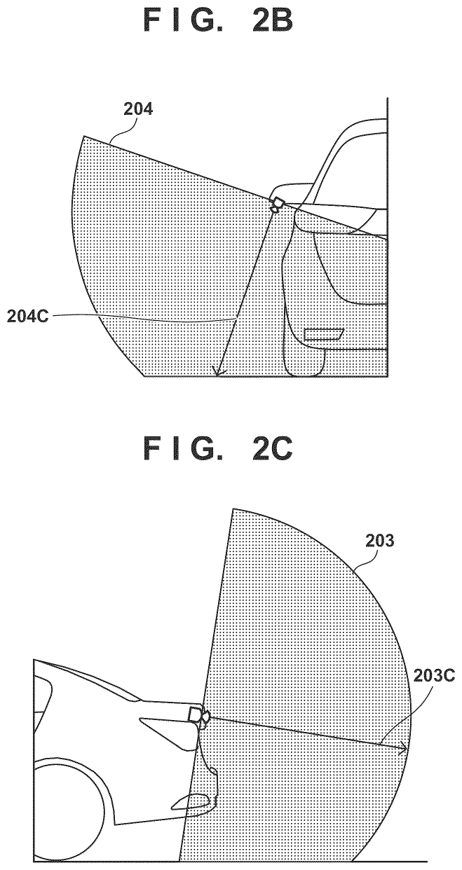

Next, with reference to FIGS. 2A to 2C, imaging ranges of the standard camera 40 and the fisheye cameras 41 to 44 will be described. FIG. 2A illustrates an imaging range in a horizontal direction of each camera, FIG. 2B illustrates an imaging range in a vertical direction of the fisheye camera 44 attached to the left side mirror of the vehicle 1, and FIG. 2C illustrates an imaging range in the vertical direction of the fisheye camera 43 attached to the rear portion of the vehicle 1.

First, imaging ranges of the vehicle 1 in plan view (that is, in the horizontal direction of the vehicle 1) will be described with reference to FIG. 2A. The standard camera 40 images scenery included in an imaging range 200. An imaging center 200C of the standard camera 40 faces a directly front side of the vehicle 1. The horizontal angle of view of the standard camera 40 may be less than 90°, and may be about 45° or about 30°, for example.

The fisheye camera 41 images scenery included in an imaging range 201. An imaging center 201C of the fisheye camera 41 faces the directly front side of the vehicle 1. The fisheye camera 42 images scenery included in an imaging range 202. An imaging center 202C of the fisheye camera 42 faces the lower right side of the vehicle 1. The fisheye camera 43 images scenery included in an imaging range 203. An imaging center 203C of the fisheye camera 43 faces the directly rear side of the vehicle 1. The fisheye camera 44 images scenery included in an imaging range 204. An imaging center 204C of the fisheye camera 44 faces the lower left side of the vehicle 1. The horizontal angles of view of the fisheye cameras 41 to 44 may be greater than 90°, greater than 150°, or greater than 180°, and may be about 180°, for example. FIG. 2A illustrates an example in which the horizontal angles of view of the fisheye cameras 41 to 44 are each 180°.

The imaging range 201 can be divided into an area 201L on a diagonally front left side of the vehicle 1, an area 201F on the directly front side of the vehicle 1, and an area 201R on the diagonally front right side of the vehicle 1. The imaging range 202 can be divided into an area 202L on a diagonally front right side of the vehicle 1, an area 202F on the directly right lateral side of the vehicle 1, and an area 202R on the diagonally rear right side of the vehicle 1. The imaging range 203 can be divided into an area 203L on a diagonally rear right side of the vehicle 1, an area 203F on the directly rear side of the vehicle 1, and an area 203R on the diagonally rear left side of the vehicle 1. The imaging range 204 can be divided into an area 204L on the diagonally rear left side of the vehicle 1, an area 204F on the directly left lateral side of the vehicle 1, and an area 204R on the diagonally front left side of the vehicle 1. The imaging range 201 may be evenly divided into the three areas 201L, 201F, and 201R (that is, such that the angles of view of the respective areas are equal). The other imaging ranges 202 to 204 may also be evenly divided into three.

Since the standard camera 40 and the fisheye cameras 41 to 44 have the imaging ranges 200 to 204, respectively, as described above, the directly front side and the four diagonal directions of the vehicle 1 are included in the imaging ranges of two separate cameras. Specifically, the directly front side of the vehicle 1 is included in both the imaging range 200 of the standard camera 40 and the area 201F of the imaging range 201 of the fisheye camera 41. The diagonally front right side of the vehicle 1 is included in both the area 201R of the imaging range 201 of the fisheye camera 41 and the area 202L of the imaging range 202 of the fisheye camera 42. The same applies to the other three diagonal directions of the vehicle 1.

Next, imaging ranges in the vertical direction of the vehicle 1 will be described with reference to FIGS. 2B and 2C. In FIG. 2B, the imaging range in the vertical direction of the fisheye camera 44 will be described, and in FIG. 2C, the imaging range in the vertical direction of the fisheye camera 43 will be described. The same may apply to the imaging ranges in the vertical direction of the other fisheye cameras 41 and 42.

The angle of view in the vertical direction of the fisheye cameras 41 to 44 may be greater than 90°, greater than 150°, or greater than 180°, and may be about 180°, for example. FIGS. 2B and 2C each illustrate an example in which the angle of view in the vertical direction of the fisheye cameras 41 to 44 is 180°. In the illustrated example, the imaging center 203C of the fisheye camera 43 faces a lower side (toward the ground side) than a direction parallel to the ground. Instead of this, the imaging center 203C of the fisheye camera 43 may face a direction parallel to the ground, or may face an upper side (toward the opposite side of the ground) than the direction parallel to the ground. In addition, the imaging center 204C of the fisheye camera 44 faces a lower side (toward the ground side) than the direction parallel to the ground. That is, the imaging center 204C of the fisheye camera 44 faces the lower left side of the vehicle 1. The imaging center 204C of the fisheye camera 44 may face the vertically lower side.

In addition, the imaging centers 201C to 204C of the respective fisheye cameras 41 to 44 may face different directions from one another in the vertical direction. Furthermore, in the present embodiment, an example in which the fisheye cameras 41 to 44 corresponding to the front side, right side, rear side, and left side of the vehicle 1, respectively, are disposed has been described, but the present invention is not limited to this example. The fisheye cameras may be disposed on the right side and the left side, and the standard cameras may be disposed on the front side and the rear side.

### <Processing>

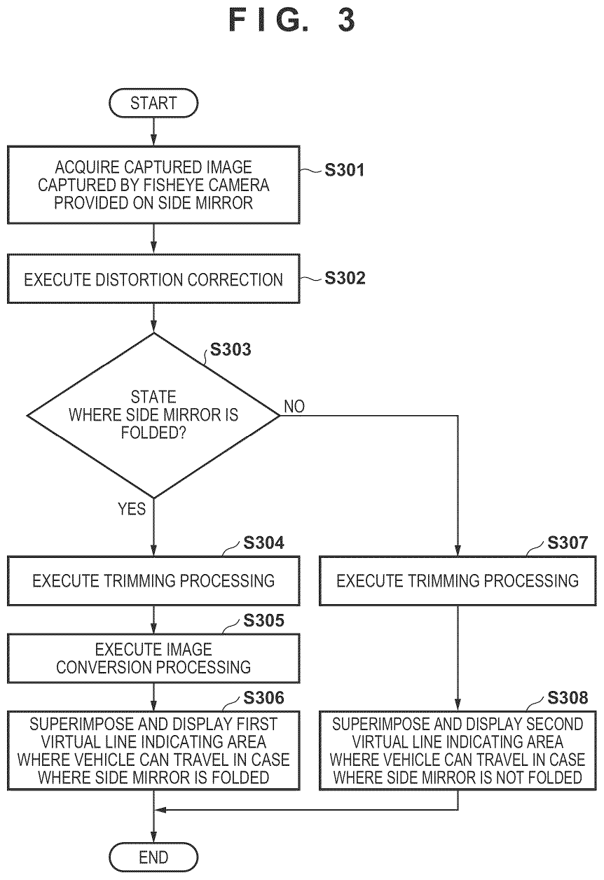

Next, a procedure of processing performed by the ECU 22 that functions as the image processing apparatus according to an embodiment will be described with reference to the flowchart of FIG. 3 and FIGS. 4 to 6.

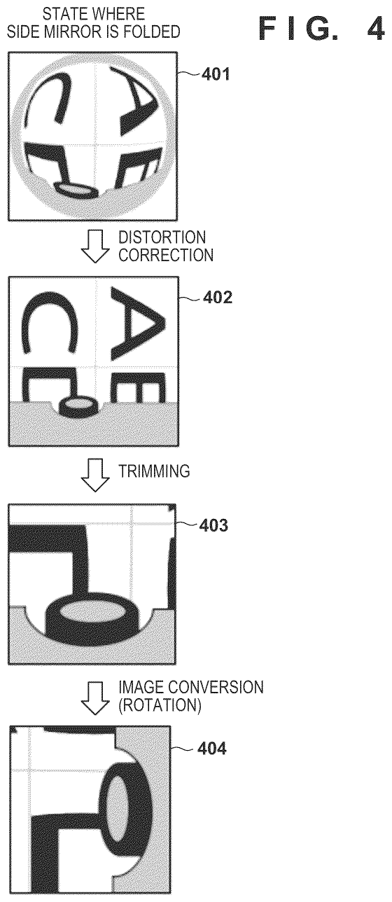

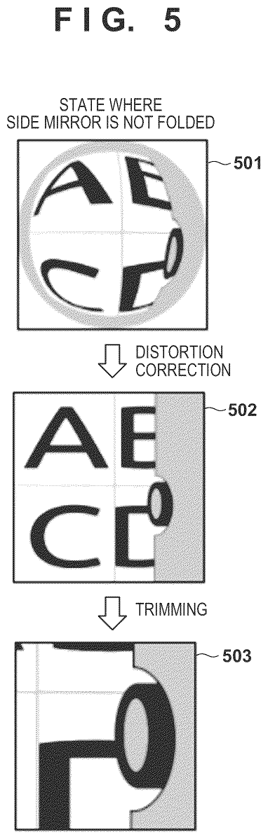

In step S301, the ECU 22 acquires a captured image captured by a fisheye camera provided on a side mirror. Here, FIG. 4 is an explanatory diagram of processing on a captured image acquired in a state where the side mirror according to the embodiment is folded. In addition, FIG. 5 is an explanatory diagram of processing on a captured image acquired in a state where the side mirror according to the embodiment is not folded. In FIGS. 4 and 5, alphabets A, B, C, and D are marked on the ground, and these are intended to facilitate understanding and recognizing changes in an image by each process of distortion correction, trimming, and image conversion. Note that there are no such marks on real roads (ground). In this step, a captured image 401 or a captured image 501 is acquired. Note that, in the following description, a captured image captured by the fisheye camera 44 provided on the left side mirror will be described as an example, but similar processing is also performed on a captured image captured by the fisheye camera 42 provided on the right side mirror. As a situation where it is necessary to fold the side mirror, for example, a situation is assumed where a vehicle travels at low speed with the side mirrors folded, while checking surrounding images when traveling forward on a narrow road or traveling backward to park in a narrow parking space.

In step S302, the ECU 22 executes distortion correction processing (conversion processing from a fisheye image to a planar image) on the captured image captured by the fisheye camera. Once the distortion correction is executed, a corrected image 402 or a corrected image 502 is acquired.

In step S303, the ECU 22 determines whether the captured image has been acquired in a state where the side mirror is folded. This can be determined from a control state of the side mirror. In a case where this step is Yes, the processing proceeds to step S304. On the other hand, in a case where this step is No, the processing proceeds to step S307.

In step S304, the ECU 22 executes trimming processing of trimming a predetermined range on a corrected image. Specifically, the trimming processing is executed on the corrected image 402 to acquire a trimmed image 403. Here, the predetermined range may be a range including the front wheel from a vehicle body end portion toward the front side and the lateral side in a case where the vehicle 1 is traveling forward (or a shift lever is in a D range). On the other hand, the predetermined range may be a range including the rear wheels from the vehicle body end portion toward the rear side and the lateral side in a case where the vehicle 1 is traveling backward (or the shift lever is in a R range). As a result, the user can travel forward or backward while checking the surrounding environment, which improves the convenience of the user. In addition, the trimming range in step S304 is controlled to be the same as the trimming range in step S307.

In step S305, the ECU 22 executes image conversion processing on a trimmed image. In the present embodiment, folding of the side mirror causes rotation of about 90°, for example. By performing image conversion (image rotation) by the rotation angle of the side mirror, the orientation can be converted into the same orientation as the orientation in a state where the side mirror is not folded. Specifically, the trimmed image 403 is image-converted to acquire a converted image 404.

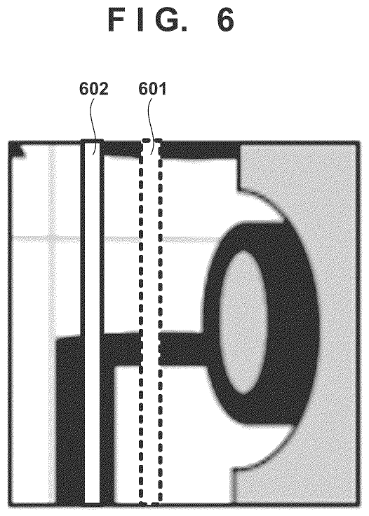

In step S306, the ECU 22 performs display control to superimpose a virtual line indicating an area where the vehicle 1 can travel in a case where the side mirror is folded on the converted image and display it on the screen of the display device 92. Details of the superimposition display of the virtual line will be described later with reference to FIG. 6.

In step S307, the ECU 22 executes trimming processing of trimming a predetermined range on a corrected image. Specifically, the trimming processing is executed on the corrected image 502 to acquire a trimmed image 503. Here, the predetermined range is similar to the range described in step S304. In addition, the trimming range in step S307 is controlled to be the same as the trimming range in step S304.

In step S308, the ECU 22 performs display control to superimpose a virtual line indicating an area where the vehicle 1 can travel in a case where the side mirror is not folded on the trimmed image and display it on the screen of the display device 92. Details of the superimposition display of the virtual line will be described later with reference to FIG. 6.

Here, the superimposition display will be described with reference to FIG. 6. FIG. 6 is an explanatory diagram of a state where a virtual line is superimposed on a converted image or a trimmed image according to an embodiment. A first virtual line 601 is a virtual line superimposed on the converted image 404 in the state where the side mirror is folded. A second virtual line 602 is a virtual line superimposed on a trimmed image 503 in the state where the side mirror is not folded. The user can easily determine whether the vehicle can travel without collision by viewing the image to check the positional relationship between the virtual line and surrounding objects of the vehicle 1.

The first virtual line 601 is separated from the vehicle 1 by a first distance. The second virtual line 602 is separated from the vehicle 1 by a second distance longer than the first distance. This is because the vehicle 1 can travel even if the area width is relatively narrow in the state where the side mirror is folded, but it is necessary to secure a relatively wide area width for the vehicle 1 to travel in the state where the side mirror is not folded. Accordingly, a series of processing steps illustrated in FIG. 3 ends.

Note that, in the above-described embodiment, the processing up to the processing of superimposing and displaying the virtual line has been executed, but the converted image may be displayed without superimposing the virtual line. Alternatively, instead of and/or in addition to the processing of S306 and S308, object detection processing may be executed on the converted image generated in S305 or the trimmed image generated in S307 to detect an obstacle. Furthermore, a first warning may be notified in a case where an obstacle is detected. In addition, in a case where the virtual line and the obstacle intersect, a second warning emphasized more than the first warning may be notified.

In addition, in the above-described embodiment, an example in which the fisheye cameras are disposed on the left and right side mirrors has been described, but the present invention is not limited to this example. The processing of the present embodiment can also be applied to a case where wide-angle standard cameras are disposed on the left and right side mirrors. In that case, the distortion correction processing in S302 is skipped.

In addition, in the above-described embodiment, an example of performing the trimming processing has been described, but the trimming processing may not be performed. In that case, the processing of S304 or S307 is skipped.

Furthermore, in the above-described embodiment, the processing on a captured image by a fisheye camera provided on one of the left and right side mirrors has been described, but actually, a left captured image and a right captured image acquired by the fisheye cameras 44 and 42 provided on both the left and right side mirrors may be displayed side by side on the display device 92. Alternatively, a left converted image obtained by converting the left captured image and a right converted image obtained by converting the right captured image may be displayed side by side on the display device 92. The first virtual line 601 and the second virtual line 602 may also be superimposed on the left and right images, respectively, and displayed side by side.

As described above, in the present embodiment, in a case where a captured image is acquired in the first state where the side mirror is folded, the captured image is converted (rotated) so as to have the same orientation as in a case where the captured image is acquired in the second state where the side mirror is not folded.

As a result, it is possible to prevent the orientation of the acquired image from changing due to the change in the orientation of the side mirror, which allows the user to appropriately grasp the surrounding environment. In addition, even in a case where the vehicle travels on a narrow path with the side mirror folded, it is possible for the user to appropriately grasp the surrounding environment, which further improves the safety of driving.

### SUMMARY OF EMBODIMENTS

1. The image processing apparatus according to the above embodiments is an image processing apparatus (22) configured to process a captured image acquired by an imaging unit (42, 44) provided on a side mirror of a vehicle (1), the image processing apparatus comprising:
an image conversion unit (22) configured to convert the captured image based on a state of the side mirror, wherein
in a case where the captured image is acquired in a first state where the state of the side mirror is folded, the image conversion unit is configured to convert the captured image so as to have the same orientation as in a case where the captured image is acquired in a second state where the side mirror is not folded.

According to this embodiment, it is possible for a user to appropriately grasp a surrounding environment (particularly, the environment on the left and right sides of the vehicle).
2. The image processing apparatus according to the above embodiments, further comprising a processing unit (22) configured to perform processing of trimming a predetermined range on the captured image before the image conversion unit converts the captured image.

According to this embodiment, since the processing can be performed only in an area of interest, it is possible to acquire an image of an area that the user wishes to visually recognize.
3. The image processing apparatus according to the above embodiments, wherein in a case where the vehicle is traveling forward, the predetermined range is a range including a front wheel from a vehicle body end portion toward a front side and a lateral side.

According to this embodiment, it is possible to acquire information on the front lateral side of the vehicle while traveling forward.
4. The image processing apparatus according to the above embodiments, wherein in a case where the vehicle is traveling backward, the predetermined range is a range including a rear wheel from a vehicle body end portion toward a rear side and a lateral side.

According to this embodiment, it is possible to acquire information on the rear lateral side of the vehicle while traveling backward.
5. The image processing apparatus according to the above embodiments, further comprising a display control unit (22, 28) configured to display, on a display device (92), a converted image of the captured image in the first state or the captured image in the second state, wherein
the display control unit is configured to superimpose a virtual line (601, 602) indicating an area where the vehicle can travel on the converted image or the captured image.

According to this embodiment, a boundary of an area where the vehicle can travel is easily recognized, and it is possible to easily recognize whether the vehicle can travel without collision with a surrounding object by viewing a displayed image.

6. The image processing apparatus according to the above embodiments, wherein
the display control unit is configured to:
   superimpose a first virtual line (601) separated from the vehicle by a first distance on the converted image in the first state; and
   superimpose a second virtual line (602) separated from the vehicle by a second distance longer than the first distance on the captured image in the second state.

This makes it possible to recognize the boundary of the area where the vehicle can travel in more detail both in a case where the side mirror is folded and a case where the side mirror is not folded. This makes it easier to recognize whether the vehicle can travel on a narrow road if the side mirror is folded.
7. The image processing apparatus according to the above embodiments, wherein the display control unit is configured to display a left captured image and a right captured image acquired by respective imaging units provided on left and right side mirrors of the vehicle side by side on the display device, or display a left converted image obtained by converting the left captured image and a right converted image obtained by converting the right captured image side by side on the display device.

This makes it possible to easily recognize the situations on the left and right sides of the vehicle on one screen. This makes it easy to finely adjust a driver's driving operation (steering operation) on the steering wheel 31.
8. The image processing apparatus according to the above embodiments, wherein
the imaging unit is a fisheye camera (42, 44), and further comprises a correction unit (22) configured to perform distortion correction on the captured image, and
the image conversion unit is configured to convert a corrected image on which the distortion correction has been performed by the correction unit.

According to this embodiment, since a wide range can be imaged, it is possible to eliminate blind spots. In addition, it is also easy to trim an image of an area of interest from a wide-range captured image.
9. The image processing apparatus according to the above embodiments, wherein the imaging unit is configured to image a lower side from the side mirror.

According to this embodiment, it is possible to acquire information on a lateral side of the vehicle.
10. The vehicle according to the above embodiments is a vehicle comprising the image processing apparatus according to the above embodiments.

According to this embodiment, it is possible to achieve processing of the image processing apparatus in the vehicle.
11. The control method of an image processing apparatus according to the above embodiments is a control method of an image processing apparatus (22) configured to process a captured image acquired by an imaging unit (42, 44) provided on a side mirror of a vehicle (1), the control method comprising:
Converting (S305) the captured image based on a state of the side mirror, wherein
the converting includes, in a case where the captured image is acquired in a first state where the state of the side mirror is folded, converting the captured image so as to have the same orientation as in a case where the captured image is acquired in a second state where the side mirror is not folded.

According to this embodiment, it is possible for a user to appropriately grasp a surrounding environment (particularly, the environment on the left and right sides of the vehicle).
12. The program according to the above embodiments is a program for causing a computer to function as the image processing apparatus according to the above embodiments.

According to this embodiment, it is possible to achieve functions of the image processing apparatus as a program.
13. The storage medium according to the above embodiments is a storage medium storing a program for causing a computer to function as the image processing apparatus according to the above embodiments.

According to this embodiment, it is possible to achieve functions of the image processing apparatus as a storage medium.

According to the present invention, it is possible for a user to appropriately grasp a surrounding environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus configured to process a captured image acquired by an imaging unit provided on a side mirror of a vehicle, the image processing apparatus comprising:
an image conversion unit configured to convert the captured image based on a state of the side mirror, wherein
in a case where the captured image is acquired in a first state where the state of the side mirror is folded, the image conversion unit is configured to convert the captured image so as to have the same orientation as in a case where the captured image is acquired in a second state where the side mirror is not folded.

2. The image processing apparatus according to claim 1, further comprising a processing unit configured to perform processing of trimming a predetermined range on the captured image before the image conversion unit converts the captured image.

3. The image processing apparatus according to claim 2, wherein in a case where the vehicle is traveling forward, the predetermined range is a range including a front wheel from a vehicle body end portion toward a front side and a lateral side.

4. The image processing apparatus according to claim 2, wherein in a case where the vehicle is traveling backward, the predetermined range is a range including a rear wheel from a vehicle body end portion toward a rear side and a lateral side.

5. The image processing apparatus according to claim 1, further comprising a display control unit configured to display, on a display device, a converted image of the captured image in the first state or the captured image in the second state, wherein
the display control unit is configured to superimpose a virtual line indicating an area where the vehicle can travel on the converted image or the captured image.

6. The image processing apparatus according to claim 5, wherein
the display control unit is configured to:
superimpose a first virtual line separated from the vehicle by a first distance on the converted image in the first state; and
superimpose a second virtual line separated from the vehicle by a second distance longer than the first distance on the captured image in the second state.

7. The image processing apparatus according to claim 5, wherein the display control unit is configured to display a left captured image and a right captured image acquired by respective imaging units provided on left and right side mirrors of the vehicle side by side on the display device, or display a left converted image obtained by converting the left captured image and a right converted image obtained by converting the right captured image side by side on the display device.

8. The image processing apparatus according to claim 1, wherein
the imaging unit is a fisheye camera, and further comprises a correction unit configured to perform distortion correction on the captured image, and
the image conversion unit is configured to convert a corrected image on which the distortion correction has been performed by the correction unit.

9. The image processing apparatus according to claim 1, wherein the imaging unit is configured to image a lower side from the side mirror.

10. A vehicle comprising the image processing apparatus according to claim 1.

11. A control method of an image processing apparatus configured to process a captured image acquired by an imaging unit provided on a side mirror of a vehicle, the control method comprising:
converting the captured image based on a state of the side mirror, wherein
the converting includes, in a case where the captured image is acquired in a first state where the state of the side mirror is folded, converting the captured image so as to have the same orientation as in a case where the captured image is acquired in a second state where the side mirror is not folded.

12. A non-transitory computer-readable storage medium storing a program for causing a computer to execute a control method of an image processing apparatus configured to process a captured image acquired by an imaging unit provided on a side mirror of a vehicle, the control method comprising:
converting the captured image based on a state of the side mirror, wherein
the converting includes, in a case where the captured image is acquired in a first state where the state of the side mirror is folded, converting the captured image so as to have the same orientation as in a case where the captured image is acquired in a second state where the side mirror is not folded.
